(19) United States
(12) Patent Application Publication
(10) Pub. No.: US 2008/0077618 A1
(43) Pub. Date: Mar. 27, 2008

(54) PRODUCTION MONITORING SYSTEM AND METHOD

(75) Inventors: ZHI-HUI WANG, Shenzhen (CN); ZE-JUN DAI, Shenzhen (CN); XIAO-YUN YUAN, Shenzhen (CN); XIAO-BING GAO, Shenzhen (CN); JIN-SONG LI, Shenzhen (CN); XIAN-GANG ZHOU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/617,766

(22) Filed: Dec. 29, 2006

(30) Foreign Application Priority Data
Sep. 22, 2006 (CN) 200610062743.7

(51) Int. Cl. G06F 17/00

(52) U.S. Cl. 707/104.1

(57) ABSTRACT

A production monitoring system for remotely monitoring a production device includes a database, a monitoring device, and a translating device. The database saves attribute data of the production device, and the attribute data includes operation signals, operation statuses, and production data. The monitoring device sends a monitoring message. The translating device translates attribute data sent by the production device into data recognizable to the monitoring device, and includes a parsing module and a performing module. The parsing module parses the attribute data sent by the production device, determines whether the attribute data matches previous attribute data, and classifies the attribute data if the attribute data does not match the previous attribute data. The performing module receives and processes the monitoring message sent by the monitoring device, receives the classified attribute data from the parsing module, and sends the classified attribute data to the monitoring device.

### BACKGROUND OF THE INVENTION

1. Field of the Invention

The invention relates to systems for managing production, and particularly to a system and method for remotely controlling production devices.

2. Description of Related Art

In production lines, robots and machine tools work together to manufacture products. Operators need to monitor the robots remotely in order to know production statuses. Usually, the robots communicate with monitoring computers of the operators as servers. Thus, the performance of the robots may be influenced by increasing numbers of monitoring computers communicating with the robots. In addition, the monitoring computers can only retrieve internal parameters of the robots, and cannot retrieve attribute data of the robots and movement statuses of the machine tools. Because the internal parameters of the robots can only be understood by experts, the operators and managers cannot know the production statuses in time, which is inconvenient and inefficient.

### SUMMARY OF THE INVENTION

In one aspect of the invention, a production monitoring system for remotely monitoring a production device is provided. The production monitoring system includes a database, a monitoring device, and a translating device. The database saves attribute data of the production device, and the attribute data includes operation signals, operation statuses, and production data. The monitoring device sends a monitoring message. The translating device connected to the production device, the monitoring device, and the database, translates attribute data sent by the production device into data recognizable to the monitoring device, and includes a parsing module and a performing module. The parsing module connected to the production device, parses the attribute data sent by the production device, determines whether the attribute data matches previous attribute data, and classifies the attribute data if the attribute data does not match the previous attribute data. The performing module connected to the parsing module, the database, and the monitoring device, receives and processes the monitoring message sent by the monitoring device, receives the classified attribute data from the parsing module, and sends the classified attribute data to the monitoring device.

In another aspect of the invention, a production monitoring method for remotely monitoring a production device is provided. The production monitoring method includes receiving attribute data sent by the production device, and determining whether the attribute data matches previous attribute data; classifying the attribute data, and sending the classified attribute data to a corresponding module if the attribute data does not match the previous attribute data; determining whether a remote control request packet sent by a monitoring device is received; parsing the remote control request packet to retrieve a plurality of remote control requests to control the production device if a remote control request packet is received.

Other advantages and novel features will become more apparent from the following detailed description when taken in conjunction with the accompanying drawings.

### BRIEF DESCRIPTION OF THE DRAWINGS

FIG. 1 is an application environment of a production monitoring system.

FIG. 2 is a schematic diagram of a production monitoring system of an exemplary embodiment of the invention.

FIG. 3 is a flowchart of a production monitoring method of another exemplary embodiment of the invention.

FIG. 4 is a flowchart of an query process of the production monitoring method.

FIG. 5 is a flowchart of a remote control process of the production monitoring method.

### DETAILED DESCRIPTION OF THE INVENTION

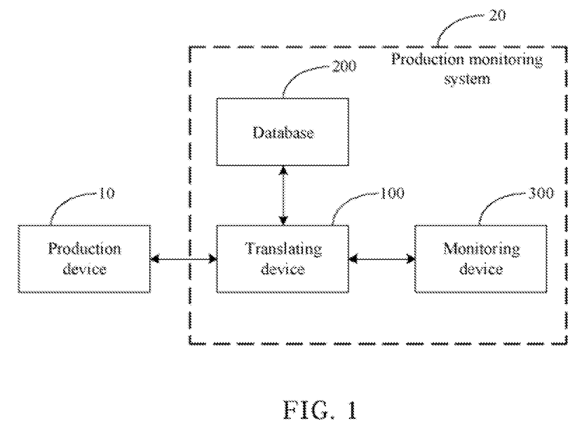

FIG. 1 is an application environment of a production monitoring system 20 of an exemplary embodiment of the invention. The production monitoring system 20 communicates with a production device 10 for remotely monitoring the production device 10. The production device 10 includes a plurality of robots (not shown) and a plurality of machine tools (not shown) connected to the plurality of robots. In the exemplary embodiment, the production monitoring system 20 is used for sending monitoring messages and receiving attribute data of the production device 10, and includes a translating device 100, a database 200, and a monitoring device 300. In the exemplary embodiment, the monitoring device 300 is a monitoring computer of an operator. The translating device 100 is connected to the database 200, the monitoring device 300, and the production device 10, and is used for translating the attribute data of the production device 10 into data recognizable to the monitoring device 300. The database 200 is used for saving the translated attribute data, that is, the recognizable data. The monitoring device 300 is used for monitoring the production device 10.

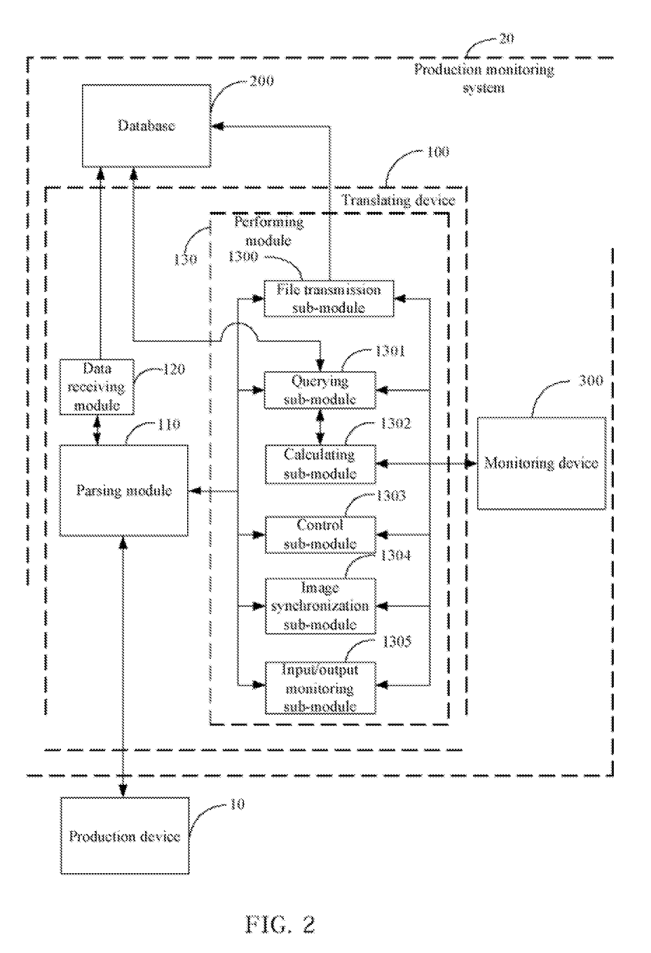

FIG. 2 is a schematic diagram of the production monitoring system 20 of an exemplary embodiment of the invention. In the exemplary embodiment, the translating device 100 includes a parsing module 110, a data receiving module 120, and a performing module 130.

The parsing module 110 is connected to the production device 10, and is used for receiving and parsing attribute data sent by the production device 10, determining whether the attribute data matches previous attribute data or has changed, and classifying the attribute data, and sending the classified attribute data if the attribute data has changed. In the exemplary embodiment, the parsing module 110 saves the previous attribute data of the production device 10, and determines whether the attribute data matches the previous attribute data to determine whether statuses of the production device 10 change. If the attribute data has changed, the parsing module 110 classifies the attribute data, and sends the classified attribute data to the data receiving module 120 and the performing module 130. In the exemplary embodiment, the attribute data includes operation signals, operation statuses, and production data.

In the exemplary embodiment, the operation signals are input/output signals of the machine tools of the production device 10, and each input/output signal corresponds to a machine tool. The operation statuses include control statuses and running statuses. The control statuses include a connectionless status, an initialization status, a manual slow-speed status, a manual full-speed status, an automatic switch status, an automatic status, and a manual-automatic switch status. The running statuses include an initialization status, a sleep status, a boot status, a closing status, a protection stopping status, an urgent stopping status, a protection rebooting status, and a sleeping reboot status. The production data includes product names, planned production amounts, finished amounts, and production hours per workpiece.

The data receiving module 120 is connected to the parsing module 110 and the database 200, and is used for receiving the classified attribute data sent by the parsing module 110 and determining whether the received attribute data needs to be saved. In the exemplary embodiment, the data receiving module 120 receives the classified attribute data, and compares the received attribute data with attribute data saved in the database 200. If the received attribute data is different from the attribute data saved in the database 200, the data receiving module 120 saves the received attribute data in the database 200 to update the database 200. In the exemplary embodiment, the classified attribute data received by the data receiving module 120 includes the production data and the operation status of the production device 10.

In the exemplary embodiment, the data receiving module 120 further determines whether a new production device 10 is added according to the operation statuses of the attribute data sent by the parsing module 110, and sends a new production device index to the database 200 if there is a new production device 10 added. Then, the database 200 sets a data table of the new production device 10 according to the new production device index.

The performing module 130 is connected to the parsing module 110, the database 200, and the monitoring device 300, and is used for receiving and processing a monitoring message sent by the monitoring device 300, receiving the classified attribute data of the production device 10 sent by the parsing module 110, and sending the classified attribute data to the monitoring device 300. In the exemplary embodiment, the monitoring message includes a querying request and a remote control request packet. In the exemplary embodiment, the performing module includes a querying sub-module 1301, a control sub-module 1303, and an image synchronization sub-module 1304.

The querying sub-module 1301 is connected to the parsing module 110, the database 200, and the monitoring device 300, and is used for receiving the querying request sent by the monitoring device 300 and querying according to the querying request. In the exemplary embodiment, the querying sub-module 1301 further determines a type of the querying request, and queries according to the type of the querying request. The querying sub-module 1301 determines the type of the querying request according to a querying field of the querying request. The querying request includes two types: a position querying request and a database querying request. The position querying request is used for querying positions of the robots of the production device 10, and the database querying request is used for querying attribute data saved in the database 200. If the querying request is a position querying request, the querying sub-module 1301 sends the position querying request to the parsing module 110 to make the parsing module 110 retrieve position data of the production device 10 according to the position querying request. If the querying request is a database querying request, the querying sub-module 1301 sends the database querying request to the database 200 to retrieve corresponding attribute data.

The control sub-module 1303 is connected to the parsing module 110 and the monitoring device 300, and is used for determining whether a remote control request packet sent by the monitoring device 300 is received and whether the monitoring device 300 has a control right and processing correspondingly. In the exemplary embodiment, if the control sub-module 1303 determines that a remote control request packet sent by the monitoring device 300 is received, the control sub-module 1303 further determines whether the monitoring device 300 has a control right. The control sub-module 1303 determines whether the monitoring device 300 has a control right via querying of a user name table in the database 200 by the querying sub-module 1301, and the user name table includes names of users having control rights. If the monitoring device 300 has the control right, the control sub-module 1303 sends the remote control request packet to the parsing module 110 to control the production device 10.

In the exemplary embodiment, the parsing module 110 further parses the remote control request packet sent by the control sub-module 1303 to retrieve a plurality of remote control requests therein, determines a type of the remote control requests, and processes correspondingly. The parsing module 110 determines the type of the remote control requests according to a value of a control field of each of the remote control requests. In the exemplary embodiment, the control field of the remote control requests includes an input/output field, a running status field, a control status field, and a position field. If the remote control requests have an input/output control request, the parsing module 110 sends the input/output control request to the production device 10 to change input/output data of the machine tools of the production device 10. If the remote control requests have a running status control request, the parsing module 110 sends the running status control request to the production device 10 to change the running statuses of the production device 10. If the remote control requests have a control status control request, the parsing module 110 sends the control status control request to the production device 10 to change the control statuses of the production device 10. If the remote control requests have a position control request, the parsing module 110 sends the position control request to the production device 10 to change the position data of the production device 10.

The parsing module 110 sends the classified attribute data to the image synchronization sub-module 1304. The image synchronization sub-module 1304 is connected to the parsing module 110 and the monitoring device 300, and is used for translating the received attribute data of the production device 10 into image data. In the exemplary embodiment, the image synchronization sub-module 1304 receives the attribute data of the production device 10 sent by the parsing module 110, translates the received attribute data into the image data, and sends the image data to the monitoring device 300.

In the exemplary embodiment, the performing module 130 further includes a file transmission sub-module 1300, a calculating sub-module 1302, and an input/output monitoring sub-module 1305.

The file transmission sub-module 1300 is connected to the parsing module 110, the database 200, and the monitoring device 300, and is used for determining whether a file transmission request sent by the monitoring device 300 is received. If the file transmission sub-module 1300 determines that a file transmission request is received, the file transmission sub-module 1300 establishes a connection between the monitoring device 300 and the production device 10, sends files sent by the monitoring device 300 to the production device 10 via the parsing module 110. The file transmission sub-module 1300 further compares versions or time of the transmitted files with files saved in the database 200, and saves the transmitted files in the database 200 if the versions and time are different. In the exemplary embodiment, the files include system files, configuration files, and program files of the production device 10.

The calculating sub-module 1302 is connected to the querying sub-module 1301 and the monitoring device 300, and is used for calculating an operating rate of the production device 10. In the exemplary embodiment, the calculating sub-module 1302 receives a calculating request sent by the monitoring device 300, sends a database querying request to the querying sub-module 1301 to query the operation statuses of the production device 10 from the database 200, and calculates the operating rate of the production device 10 according to the operation statuses.

In the exemplary embodiment, the parsing module 110 further sends the operation signals of the classified attribute data to the input/output monitoring sub-module 1305. The input/output monitoring sub-module 1305 is connected to the parsing module 110 and the monitoring device 300, and is used for monitoring the operation signals sent by the parsing module 110. In the exemplary embodiment, the input/output monitoring sub-module 1305 receives the operation signals sent by the parsing module 110, sets a mapping between the operation signals and the machine tools of the production device 10, and sends the mapping to the monitoring device 300.

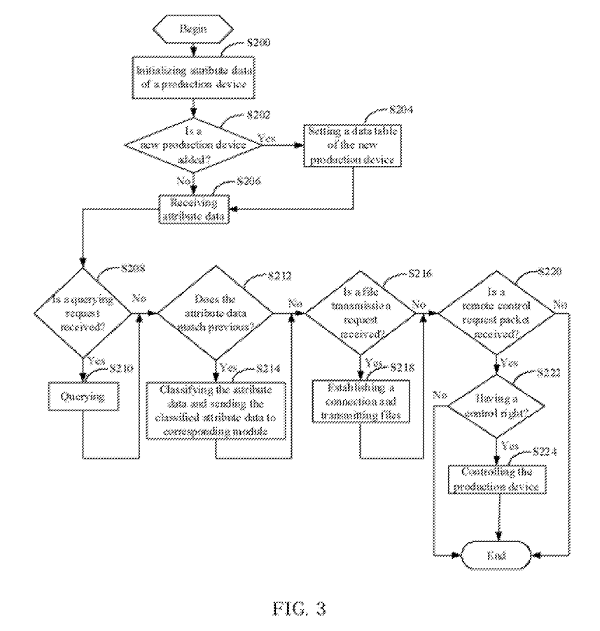

FIG. 3 is a flowchart of a production monitoring method of an exemplary embodiment of the invention. In step S200, the translating device 100 initializes attribute data of the production device 10. In the exemplary embodiment, the attribute data includes operation signals, operation statuses, and production data of the production device 10.

In step S202, the data receiving module 120 determines whether a new production device 10 is added according to the operation statuses sent by the parsing module 110.

In step S204, if a new production device 10 is added, the data receiving module 120 sends a new production device index to the database 200, the database 200 sets a data table of the new production device 10 according to the new production device index, and saves the data table. Then, the process goes to step S206.

If no new production device 10 is added, in step S206, the parsing module 110 receives attribute data sent by the production device 10.

In step S208, the querying sub-module 1301 determines whether a querying request sent by the monitoring device 300 is received.

In step S210, if a querying request is received, the querying sub-module 1301 queries according to the querying request, and sends the querying results to the monitoring device 300. Then the process goes to step S212.

If the querying sub-module 1301 determines that no querying request is received, in step S212, the parsing module 110 parses the attribute data of the production device 10, and determines whether the attribute data matches previous attribute data saved therein.

If the parsing module 110 determines that the attribute data does not match the previous attribute data, in step S214, the parsing module 110 classifies the received attribute data, and sends the classified attribute data to the corresponding module. Then the process goes to step S216. In the exemplary embodiment, the parsing module 110 sends the operation signals to the input/output monitoring sub-module 1305 and the image synchronization sub-module 1304, and sends the operation statuses and the production data to the data receiving module 120 and the image synchronization sub-module 1304.

If the attribute data matches the previous attribute data, in step S216, the file transmission sub-module 1300 determines whether a file transmission request sent by the monitoring device 300 is received.

If a file transmission request is received, in step S218, the file transmission sub-module 1300 establishes a connection between the monitoring device 300 and the production device 10, and transmits files therebetween via the parsing module 110. Then the process goes to step S220.

If no file transmission request is received, in step S220, the control sub-module 1303 determines whether a remote control request packet sent by the monitoring device 300 is received. If no remote control request packet is received, the process ends.

If the control sub-module 1303 receives a remote control request packet, in step S222, the control sub-module 1303 determines whether the monitoring device 300 has a control right. In the exemplary embodiment, the control sub-module 1303 determines whether the monitoring device 300 has a control right via querying of a user name table in the database 200 by the querying sub-module 1301, and the user name table includes names of users having control rights. If the monitoring device 300 has no control right, the process ends.

If the monitoring device 300 has a control right, in step S224, the monitoring device 300 controls the production device 10 via the control sub-module 1303 according to the remote control request packet.

Sequence of the above steps S208, S212, S216, and S220 can be changed.

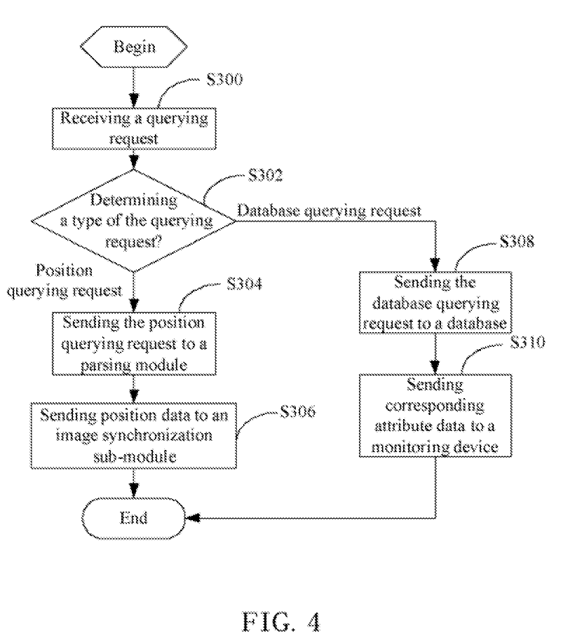

FIG. 4 is a flowchart of a querying process of the production monitoring method, that is a detailed flowchart of step S210. In step S300, the querying sub-module 1301 receives a querying request sent by the monitoring device 300.

In step S302, the querying sub-module 1301 determines a type of the querying request. In the exemplary embodiment, the querying sub-module 1301 determines the type of the querying request according to a querying field of the querying request. The querying request includes a position querying request and a database querying request.

If the querying request is a position querying request, in step S304, the querying sub-module 1301 sends the position querying request to the parsing module 110, and the parsing module 110 retrieves position data of the production device 10 according to the position querying request.

In step S306, the parsing module 110 sends the position data to the image synchronization sub-module 1304, and the image synchronization sub-module 1304 sends the position data to the monitoring device 300 to display.

If the querying request is a database querying request, in step S308, the querying sub-module 1301 sends the database querying request to the database 200 to retrieve corresponding attribute data.

In step S310, the querying sub-module 1301 sends the corresponding attribute data to the monitoring device 300.

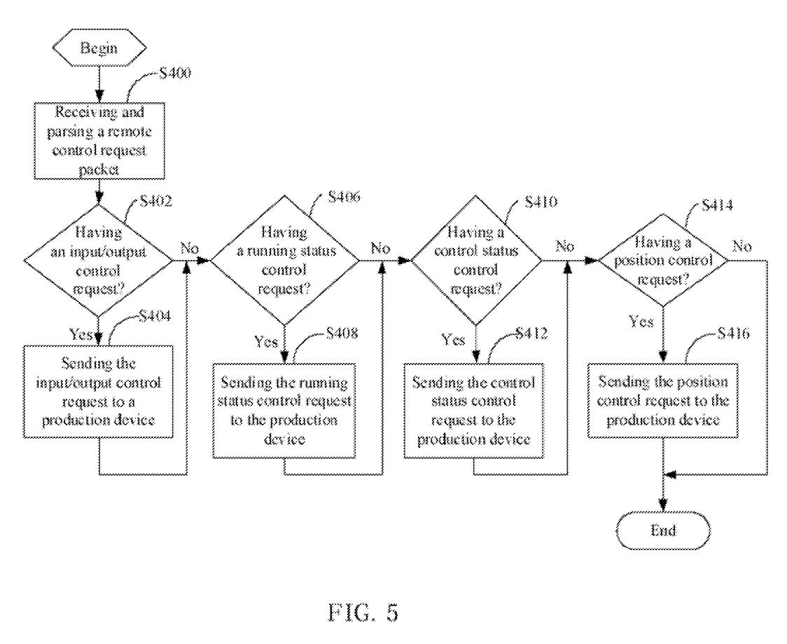

FIG. 5 is a flowchart of a remote control process of the production monitoring method, that is, a detailed flowchart of step S224. In step S400, the parsing module 110 receives a remote control request packet sent by the control sub-module 1303, and parses the remote control request packet. In the exemplary embodiment, the control sub-module 1303 parses the remote control request packet to retrieve a plurality of remote control requests therein.

In step S402, the parsing module 110 determines whether the plurality of remote control requests have an input/output control request. In the exemplary embodiment, the parsing module 110 determines a type of the remote control requests according to a value of a control field of the remote control requests. In the exemplary embodiment, the control field of the remote control request includes an input/output field, a running status field, a control status field, and a position field.

If the remote control requests have an input/output control request, in step S404, the parsing module 110 sends the input/output control request to the production device 10 to change input/output data of the machine tools of the production device 10. Then the process goes to step S406.

If the remote control requests have no input/output control requests, in step S406, the parsing module 110 further determines whether the remote control requests have a running status control request.

If the remote control requests have a running status control request, in step S408, the parsing module 110 sends the running status control request to the production device 10 to change the running statuses of the production device 10. Then, the process goes to step S410.

If the remote control requests have no running status control request, in step S410, the parsing module 110 further determines whether the remote control requests have a control status control request.

If the remote control requests have a control status control request, in step S412, the parsing module 110 sends the control status control request to the production device 10 to change the control statuses of the production device 10 according to the control request. Then the process goes to step S414.

If the remote control requests have no control status control requests, in step S414, the parsing module 110 determines whether the remote control requests have a position control request. If the remote control requests have no position control requests, the process ends.

If the remote control requests have a position control request, in step S416, the parsing module 110 sends the position control request to the production device 10 to change the position data of the production device 10.

In the exemplary embodiment, sequence of steps S402, S406, S410, and S414 can be changed.

Operators can know data of the production device 10 in real-time, and can manage the production device 10 in real-time via the production monitoring system and method. Thus, the production monitoring system and method are efficient and convenient.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A production monitoring system, for remotely monitoring a production device, comprising:
a database, for saving attribute data of the production device, the attribute data comprising operation signals, operation statuses, and production data;
a monitoring device, for sending a monitoring message; and
a translating device connected to the production device, the monitoring device, and the database, for translating attribute data sent by the production device into data recognizable to the monitoring device, comprising:
a parsing module connected to the production device, for parsing the attribute data sent by the production device, determining whether the attribute data matches previous attribute data, and classifying the attribute data if the attribute data does not match the previous attribute data; and
a performing module connected to the parsing module, the database, and the monitoring device, for receiving and processing the monitoring message sent by the monitoring device, receiving the classified attribute data from the parsing module, and sending the classified attribute data to the monitoring device.

2. The production monitoring system of claim 1, wherein the monitoring message comprises a querying request and a remote control request packet.

3. The production monitoring system of claim 2, wherein the performing module comprises:
a control sub-module connected to the parsing module and the monitoring device, for determining whether a remote control request packet sent by the monitoring device is received and sending the remote control request packet to the parsing module if the remote control request packet is received; and
an image synchronization sub-module connected to the parsing module and the monitoring device, for translating the attribute data of the production device into image data and sending the image data to the monitoring device.

4. The production monitoring system of claim 3, wherein the performing module further comprises:
a querying sub-module, for receiving a querying request sent by the monitoring device, determining a type of the querying request, and querying according to the type of the querying request.

5. The production monitoring system of claim 4, wherein the querying request comprises a position querying request and a database querying request.

6. The production monitoring system of claim 5, wherein the querying sub-module sends the position querying request to the parsing module to retrieve position data of the production device, and sends the database querying request to the database to retrieve corresponding attribute data.

7. The production monitoring system of claim of claim 4, wherein the performing module further comprises:
a calculating sub-module connected to the querying sub-module and the monitoring device, for calculating an operating rate of the production device according to the operation statuses of the attribute data;
an input/output monitoring sub-module connected to the parsing module and the monitoring device, for monitoring the operation signals of the attribute data sent by the parsing module; and
a file transmission sub-module connected to the parsing module, the database, and the monitoring device, for determining whether a file transmission request sent by the monitoring device is received and establishing a connection between the monitoring device and the production device to send files sent by the monitoring device to the production device.

8. The production monitoring system of claim 7, wherein the file transmission sub-module further compares versions and time of the transmitted files and files saved in the database, and saves the transmitted files in the database if the versions or time of the transmitted file and files saved in the database are different from each other.

9. The production monitoring system of claim 3, wherein the parsing module further parses the remote control request packet sent by the control sub-module to retrieve a plurality of remote control requests therein, determines a type of the remote control requests, and changes corresponding data of the production device according to the type of the remote control requests.

10. The production monitoring system of claim 1, wherein the translating device further comprises a data receiving module connected to the parsing module and the database, for receiving the classified attribute data from the parsing module and determining whether the classified attribute data needs to be saved.

11. A production monitoring method, for remotely monitoring a production device, comprising:
receiving attribute data sent by the production device, and determining whether the attribute data matches previous attribute data;
classifying the attribute data, and sending the classified attribute data to corresponding module if the attribute data does not match the previous attribute data;
determining whether a remote control request packet sent by a monitoring device is received;
parsing the remote control request packet to retrieve a plurality of remote control requests to control the production device if a remote control request packet is received.

12. The production monitoring method of claim 11, further comprising:
determining whether an querying request sent by the monitoring device is received; and
receiving the querying request, determining a type of the querying request, and querying according to the type of the querying request.

13. The production monitoring method of claim 12, wherein the step of querying according to the type of the querying request comprises steps of:
if the querying request has a position querying request, sending the position querying request to a parsing module;
retrieving position data of the production device, and sends the position data to an image synchronization sub-module; and
sending the position data to a monitoring device to display.

14. The production monitoring method of claim 12, wherein the step of querying according to the type of the querying request comprises steps of:
if the querying request has a database querying request, sending the database querying request to a database to retrieve corresponding attribute data, and sending the corresponding attribute data to the monitoring device.

15. The production monitoring method of claim 11, wherein the step of parsing the remote control request packet to retrieve a plurality of remote control requests to control the production device comprises:
receiving the remote control request packet, and sending the remote control request packet to a parsing module;
parsing the remote control request packet to retrieve a plurality of remote control requests therein;
determining whether the remote control requests have an input/output control request; and
sending the input/output control request to the production device to change input/output data of the production device if the remote control request have an input/output control request.

16. The production monitoring method of claim 15, wherein the step of parsing the remote control request packet to retrieve a plurality of remote control requests to control the production device further comprises:
determining whether the remote control requests have a running status control request; and
sending the running status control request to the production device to change running statuses of the production device if the remote control requests have a running status control request.

17. The production monitoring method of claim 15, wherein the step of parsing the remote control request packet to retrieve a plurality of remote control requests to control the production device further comprises:
determining whether the remote control requests have a control status control request; and
sending the control status control request to the production device to change control statuses of the production device if the remote control requests have a control status control request.

18. The production monitoring method of claim 15, wherein the step of parsing the remote control request packet to retrieve a plurality of remote control requests to control the production device further comprises:
determining whether the remote control requests have a position control request; and
sending the position control request to the production device to change position data of the production device if the remote control requests have a position control request.
